(19) United States
(12) Patent Application Publication
(10) Pub. No.: US 2008/0042312 A1
(43) Pub. Date: Feb. 21, 2008

(54) Deep-dyeable modified polylactic acid fiber

(75) Inventors: Shih-Hsiung Chen, Tauyan (TW); Ping-Sheng Lai, Tauyan (TW)

Correspondence Address: FOLEY AND LARDNER LLP;SUITE 500, 3000 K STREET NW, WASHINGTON, DC, 20007, US

(73) Assignee: FAR EASTERN TEXTILE LTD.

(21) Appl. No.: 11/790,573

(22) Filed: Apr. 26, 2007

(30) Foreign Application Priority Data
Jun. 27, 2006 (TW) 095123139

(51) Int. Cl. D01F 6/92; C08G 63/08

(52) U.S. Cl. 264/103; 525/450; 525/55

(57) ABSTRACT

A deep-dyeable modified polylactic acid fiber includes a modified polylactic acid composition containing polylactic acid and a modifying polymer. The modifying polymer is an aliphatic polyester other than polylactic acid, an aromatic polyester, an aliphatic-aromatic copolyester, or combinations thereof. The modified polylactic acid composition, when dyed, provides a decreased L-value compared to a non-modified polylactic acid composition that is dyed under the same dyeing conditions as the modified polylactic acid composition and that contains the polylactic acid but is free of the modifying polymer.

### CROSS-REFERENCE TO RELATED APPLICATION

This application claims priority of Taiwanese Application No. 095123139, filed on Jun. 27, 2006.

### BACKGROUND OF THE INVENTION

1. Field of the Invention

The invention relates to a deep-dyeable modified polylactic acid fiber, and more particularly to a deep-dyeable modified polylactic acid fiber having heat-resistant and biodegradable properties. This invention also relates to a modified polylactic acid composition which is easily processable to form the deep-dyeable modified polylactic acid fiber and a method for producing a deep-dyeable polylactic acid fabric from the modified polylactic acid composition.

2. Description of the Related Art

Recently, environmental pollution has severely affected the ecologies and the health of human beings. Therefore, there is a demand for developing environmental-friendly products.

In connection with synthetic fibers, a fiber made from polylactic acid has a melting point of about 170° C. and is thus heat resistant. Furthermore, such a fiber exhibits a fiber strength as high as that of a conventional polyester fiber. In addition, polylactic acid can be obtained from reproducible plant materials, such as corn starch, sugar beet, or the like. Therefore, there is no problem in connection with shortage of source raw material. Furthermore, polylactic acid fibers are easily digested by microorganisms when they become waste, and thus, can used as green manure for recycling. Accordingly, a fiber made from polylactic acid is one of the fibers having the most potential for further development.

It is known that a fabric is made from dyed fibers so as to provide the fabric with a variety of patterns to enhance aesthetic appeal thereof. Therefore, whether a material for making a fiber can be dyed and up to which extent it can be dyed are critical to the application of the fiber made therefrom.

Generally, polylactic acid fibers are dyed with a dispersive dye. However, since no good bonding can be formed between polylactic acid molecules and dispersive dye molecules, conventional polylactic acid fibers cannot be deeply dyed in comparison with polyester fibers when these two types of the fibers are dyed under the same conditions with the same dye of the same concentration. Further, the polylactic acid fibers, even when deeply dyed, exhibit poor color fastness to washing. Therefore, the conventional polylactic acid fibers must be dyed in an increased dye concentration. By doing so, the cost for dying the conventional polylactic acid fibers is increased, and the cost for disposing of the used dye waste is increased as well.

Accordingly, there is a need to obtain a deep-dyeable polylactic acid fiber without the deficiency mentioned above.

### SUMMARY OF THE INVENTION

Therefore, the first object of the present invention is to provide a deep-dyeable modified polylactic acid fiber having heat-resistant and biodegradable properties.

The second object of the present invention is to provide a modified polylactic acid composition which is easily processable to form the deep-dyeable modified polylactic acid fiber.

The third object of the present invention is to provide a method for making a deep-dyeable polylactic acid fabric from the modified polylactic acid composition.

In the first aspect of this invention, the deep-dyeable modified polylactic acid fiber includes a modified polylactic acid composition containing polylactic acid and a modifying polymer. The modifying polymer is an aliphatic polyester other than polylactic acid, an aromatic polyester, an aliphatic-aromatic copolyester, or combinations thereof. The modified polylactic acid composition, when dyed, provides a decreased L-value compared to a non-modified polylactic acid composition that is dyed under the same dyeing conditions as the modified polylactic acid composition and that contains the polylactic acid but is free of the modifying polymer.

In the second aspect of this invention, the modified polylactic acid composition for forming the deep-dyeable modified polylactic acid fiber includes a polylactic acid, and 1-15% by weight of a modifying polymer based on a total weight of the modified polylactic acid composition. The modifying polymer is an aliphatic polyester other than polylactic acid, an aromatic polyester, an aliphatic-aromatic copolyester, or combinations thereof. The modified polylactic acid composition, when dyed, provides a decreased L-value compared to a non-modified polylactic acid composition that is dyed under the same dyeing conditions as the modified polylactic acid composition and that contains the polylactic acid but is free of the modifying polymer.

In the third aspect of this invention, the method for producing a deep-dyeable polylactic acid fabric from the modified polylactic acid composition includes the steps of:

a) melt spinning the modified polylactic acid composition to form a deep-dyeable polylactic acid fiber; and

b) forming the deep-dyeable polylactic acid fiber into a yarn.

### DETAILED DESCRIPTION OF THE PREFERRED EMBODIMENTS

It was found in the present invention that a deep-dyeable modified polylactic acid fiber having improved heat resistance and color fastness to washing can be obtained when a modifying polymer, which has good binding capability to a dispersive dye and good compatibility with polylactic acid, is added to the polylactic acid to produce a modified polylactic acid composition for the polylactic acid fiber.

The modified polylactic acid composition for forming the deep-dyeable modified polylactic acid fiber includes a polylactic acid, and 1-15% by weight of a modifying polymer based on a total weight of the modified polylactic acid composition. The modifying polymer is an aliphatic polyester other than polylactic acid, an aromatic polyester, an aliphatic-aromatic copolyester, or combinations thereof.

When the modified polylactic acid composition and a non-modified polylactic acid composition free of the modifying polymer are dyed under the same dye concentration, the modified polylactic acid composition provides a decreased L-value compared to the non-modified polylactic acid composition.

The L-value used herein is a value to measure the color fastness of a material, which is in the form of pellets, for a dyed fiber. The lower the L-value, the better will be the color fastness to washing.

If the modifying polymer contained in the modified polylactic acid composition is less than 1% by weight, the fiber cannot be deep-dyed. On the other hand, if the modifying polymer contained in the modified polylactic acid composition is more than 15% by weight, the modified polylactic acid composition cannot be processed easily to form a fiber. The modifying polymer contained in the modified polylactic acid composition ranges preferably from 1 to 10% by weight, more preferably from 1 to 5% by weight, based on a total weight of the modified polylactic acid composition.

The aliphatic polyester suitable for the present invention is represented by formula (I):

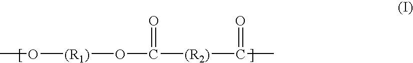

wherein R₁ and R₂ are the same or different, and independently of one another are linear or branched C₂-C₄₀ alkyl. Preferably, the aliphatic polyester has a melting point ranging from 30 to 140° C., and the examples thereof are polybutylene succinate (e.g., Bionolle 1020, Bionore 1001, and Bionore 1903 from Showa High Polymer Co., Ltd.), polybutylene succinate/adipate (e.g., EnPOl G400 from IRE Chemicals Ltd.), polybutylene adipate (e.g., FEPOL1000 series from Far Eastern Textile, Taiwan), polyethylene succinate/adipate, polybutylene succinate/carbonate, polycaprolactone, polyethylene adipate, and the like.

The aliphatic-aromatic copolyester suitable for the present invention is represented by formula (II):

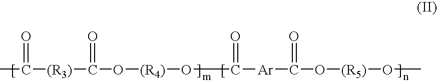

wherein
1≦m≦40;
1≦n≦4;
R₃, R₄, and R₅ are the same or different, and independently of one another are linear or branched C₂-C₄₀ alkyl; and
Ar is C₆-C₂₀ aryl.

Preferably, the aliphatic-aromatic copolyester has a melting point ranging from 50 to 200° C., and the examples thereof are polybutylene adipate/terephthalate (e.g., FEPOL2000 series from Far Eastern Textile, Taiwan, Ecoflex from BASF, or Enpol 8000 from IRE Chemicals Ltd.), polybutylene succinate/terephthalate (e.g., Biomax from DuPont), polytetramethylene adipate/terephthalate (e.g., EastarBio from Eastman Chemicals), and the like.

The aromatic polyester suitable for the present invention is represented by formula (III):

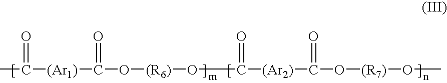

wherein
1≦m≦40;
1≦n≦40;
R₆ is linear or branched C₂-C₄₀ alkyl, or C₆-C₂₀ aryl;
R₇ is linear or branched C₂-C₄₀ alkyl; and
Ar₁ and Ar₂ are the same or different, and independently of one another are C₆-C₂₀ aryl.

Preferably, the aromatic polyester has a melting point ranging from 110 to 200° C., and the examples thereof are polyethylene terephthalate/1,3-dihydroxy-2-methylpropane alkoxylate, polyethylene terephthalate/adipate (e.g., CS-113 from Far Eastern Textile, Taiwan), or the like.

Furthermore, the modifying polymer may further include 4-10% by weight of TiO₂ based on the total weight of the modifying polymer. TiO₂ is used as a matting agent, and is blended within the modified polylactic acid composition so as to produce a semi dull type of fiber.

The modified polylactic acid composition can be processed to produce a deep-dyeable polylactic acid fabric by melt spinning the modified polylactic acid composition to form a partially oriented yarn, false twisting the partially oriented yarn to form a draw-textured yarn, and forming the draw-textured yarn into the fabric.

The fiber fineness of the partially oriented yarn and the draw-textured yarn preferably ranges from 1 to 10 denier/filament, and the fiber number thereof is 36, 48, 72, 108, or 144. The fiber of the partially oriented yarn may have any suitable cross-sectional shape, such as circular, oval, trilobal, triangular, dog-boned, flat, or hollow shape.

The following examples are provided to illustrate the preferred embodiments of the invention, and should not be construed as limiting the scope of the invention.

### EXAMPLES

Chemicals used in the examples:
1. Polylactic acid (PLA): Model No. 6201D available from Cargill-Dow LLC, U.S.A, melting point: 170° C.
2. Polybutylene succinate (PBS): Model No. Bionolle 1020 available from Showa High Polymer Co. Ltd., Japan, melting point: 114° C.
3. Polybutylene succinate/adipate (EnPol): Model No. EnPol G400 available from IRE Chemicals Ltd., Korea, melting point: 60° C.
4. Polybutylene adipate/terephthalate (PBAT-FB): synthesized by the inventors, melting point: 140° C.
5. Polybutylene adipate/terephthalate (PBAT-SD): synthesized by the inventors, melting point: 140° C.
6. Polyethylene terephthalate/adipate (CS-113): Model No. CS-113 available from Far Eastern Textile, Taiwan, melting point: 192° C.
7. Polyethylene terephthalate/1,3-dihydroxy-2-methyl propane alkoxylate (DHMPA): synthesized by the inventors, melting point: 186° C.

### The Effects of the Amounts of the Modifying Polymer on the Dyeing Property of the Modified PLA Composition

In Examples 1-6, the PLA and a variety of the modifying polymers in different amounts, as shown in Tables 1-6, were admixed to form PLA compositions in the form of pellets. The pellets were dyed for 40 minutes at a temperature of 110° C. using a blue dispersive dye at a concentration of 2.5% owf (on the weight of fabric). The L-values of the pellets were measured. The lower the L-value, the deeper the color. Comparative Example 1 in Tables 1-3 and 5-6 is a PLA composition having no modifying polymer. In Example 4, each of Samples 1-5 contains PLA, the modifying polymer, and TiO₂ as a matting agent, whereas Comparative Example 2 is a PLA composition having TiO₂ but not containing the modifying polymer.

### Example 1

In this example, the modifying polymer included in Samples 1-5 is polybutylene succinate (PBS).

TABLE 1

| Samples | PBS (wt %) | L-value |
|---|---|---|
| 1 | 3 | 18.0 |
| 2 | 6 | 18.3 |
| 3 | 9 | 18.0 |
| 4 | 12 | 18.0 |
| 5 | 15 | 18.1 |
| 6 | Comp. Ex. 1 | 22.8 |

### Example 2

In this example, the modifying polymer included in Samples 1-5 is polybutylene succinate/adipate (EnPol)

TABLE 2

| Samples | EnPol (wt %) | L-value |
|---|---|---|
| 1 | 3 | 18.4 |
| 2 | 6 | 18.4 |
| 3 | 9 | 17.5 |
| 4 | 12 | 17.9 |
| 5 | 15 | 17.5 |
| 6 | Comp. Ex. 1 | 22.8 |

### Example 3

In this example, the modifying polymer included in Samples 1-4 is polybutylene adipate/terephthalate (PBAT-FB).

TABLE 3

| Samples | PBAT-FB (wt %) | L-value |
|---|---|---|
| 1 | 3 | 17.3 |
| 2 | 6 | 16.2 |
| 3 | 9 | 15.7 |
| 4 | 12 | 15.4 |
| 5 | Comp. Ex. 1 | 22.8 |

### Example 4

In this example, the modifying polymer used in Samples 1-5 is polybutylene adipate/terephthalate (PBAT-SD), which is semi dull type. Each sample includes 6% by weight of TiO₂ based on the total weight of the modifying polymer. In Comparative Example 2, pellets were formed by admixing 98% by weight of PLA and 2% by weight of masterbatch from Easterman Company. The masterbatch is composed of 85% by weight of PLA and 15% by weight of TiO₂.

TABLE 4

| Samples | PBAT-SD (wt %) | L-value |
|---|---|---|
| 1 | 3 | 17.04 |
| 2 | 6 | 17.72 |
| 3 | 9 | 17.47 |
| 4 | 12 | 17.59 |
| 5 | 15 | 17.81 |
| 6 | Comp. Ex. 2 | 20.09 |

### Example 5

In this example, the modifying polymer included in Samples 1-6 is Polyethylene terephthalate/adipate (CS-113).

TABLE 5

| Samples | CS-113 (wt %) | L-value |
|---|---|---|
| 1 | 6 | 20.4 |
| 2 | 9 | 19.8 |
| 3 | 12 | 19.6 |
| 4 | 15 | 19.6 |
| 5 | 18 | 18.6 |
| 6 | Comp. Ex. 1 | 22.8 |

### Example 6

In this example, the modifying polymer included in Samples 1-5 is polyethylene terephthalate/1,3-dihydroxy-2-methyl propane alkoxylate (DHMPA).

TABLE 6

| Samples | DHMPA (wt %) | L-value |
|---|---|---|
| 1 | 3 | 21.4 |
| 2 | 6 | 21.5 |
| 3 | 9 | 21.1 |
| 4 | 12 | 20.3 |
| 5 | 15 | 19.9 |
| 6 | Comp. Ex. 1 | 22.8 |

From the L-values above, it is evident that the pellets containing the modifying polymer exhibit a lower L-value compared to the comparative examples containing no modifying polymer. Further, it is also evident that the greater the amount of the modifying polymer, the lower will be the L-value. The results reveal that addition of the modifying polymer to the polylactic acid enhances the deep-dyeable effect of the polylactic acid. The results also show that the deep-dyeable effect of the modified PLA composition containing the modifying polymer and TiO₂ is better than that of the non-modified PLA composition containing only TiO₂.

### Processibility of the Modified PLA Composition

### Examples 7 and 8

In Examples 7 and 8, modified PLA compositions were prepared by using 2% by weight and 3% by weight of PBAT-FB. The compositions were then melt spun to form partially oriented yarns of 130d/72f. The operating conditions were: 105° C. (drying temperature), 72 round spinneret holes, 220-230° C. (spinning temperature), 225° C. (Dow temperature), 0.55 m/min (cooling air speed), 0.6% (spinning oil per unit), 2780 m/min (take-up speed), and 40.4 g/min (spinning rate). The partially oriented yarns were thereafter twisted with a false twist crimping machine at a speed of 450 m/min and a draw ratio DR1/DR2=1.75 to produce draw-textured yarns of 75d/72f.

### Example 9

Example 9 was conducted by repeating the procedures set forth in Examples 7 and 8 except that 4% by weight of PBAT-SD was used to form the modified PLA composition, which was further processed to form the partially oriented yarns and the draw-textured yarns.

### Comparative Example 3

Comparative Example 3 was conducted by repeating the procedures set forth in Examples 7 and 8 except that the PLA composition used in the example did not contain the modifying polymer.

Examination of Examples 7-9 revealed that the partially oriented yarns and the draw-textured yarns obtained in all of Examples 7-9 have normal appearance and normal mechanical strength. Upon comparison with Comparative Example 3, the modified PLA compositions of Examples 7 and 8 exhibited good processability in terms of spinning and false-twisting. This reflects that there is no adverse effect on spinnability and the false twistability due to the addition of the modifying polymer.

### Dyeing Properties and Color Fastness to Washing

Garters were made from the draw-textured yarns of Examples 7, 8 and Comparative Example 3, respectively. Thereafter, the garters were dyed with brown and blue dispersive dyes, respectively, in a concentration of 2.5% owf, in a bath ratio of 1:15 and a temperature of 110° C. for 40 mins. Then, the L-values and the color strengths of the garters made from Example 8 and Comparative Example 3 were measured. The results are shown in Table 7.

Additionally, garters made from the draw-textured yarns of Examples 7, 8 and Comparative Example 3 were dyed with brown and blue dispersive dyes with a dye concentration of 2.5% owf, a bath ratio of 1:15 and a temperature of 110° C. for 40 mins. Then, the garters were washed with water at a temperature of 70° C. for 15 mins, and the shapes thereof were set at 130° C. for 1.5 mins. The color fastness to washing of the garters was measured according to ISO-105C06. The results are shown in Table 7.

TABLE 7

| | | Ex. 7 | Ex. 8 | Comp. Ex. 3 |
|---|---|---|---|---|
| Brown | | | | |
| L-value | | 14.0 | 14.0 | 16.4 |
| Color Strength | | — | 148.7 | 100 |
| Color Fastness to | | | | |
| Washing (grade) | | | | |
| Attached | Polyester | 3.5 | 3.5 | 3.5 |
| cloth | Nylon | 3.5 | 3.5 | 3.0 |
| | Cotton | 4.0 | 4.0 | 4.0 |
| Blue | | | | |
| L-value | | 37.1 | 36.8 | 49.5 |
| Color Strength | | — | 150.7 | 100 |
| Color Fastness to | | | | |
| Washing (grade) | | | | |
| Attached | Polyester | 4.0 | 4.0 | 4.0 |
| cloth | Nylon | 3.0 | 3.0 | 3.0 |
| | Cotton | 4.0 | 4.0 | 4.0 |

As shown in Table 7, the L-values of the garters made from the draw-textured yarns of Examples 7 and 8 are lower than that of the garter made from the draw-textured yarn of Comparative Example 3. That is, the garters made from the draw-textured yarns of Examples 7 and 8 exhibit a superior deep-dyeable property as compared to the garter made from the draw-textured yarn of Comparative Example 3. After being dyed with the brown dispersive dye, the color strength of the garter made from the draw-textured yarn of Example 8 was 148.7 and was determined using the color strength (100) of the garter made in Comparative Example 3 as a standard. Furthermore, after being dyed with the blue dispersive dye, the color strength of the garter made from the draw-textured yarn of Example 8 was 150.7 and was determined using the color strength (100) of the garter made in Comparative Example 3 as a standard. Additionally, as for the color fastness to washing, the grades of the garters made from the draw-textured yarns of Examples 7 and 8 are more than 3.0, which means that the color strength of the garters made from the modified polylactic acid fiber of the present invention reached the commercial standard.

Furthermore, the color strength and the color fastness to washing of the garter made from the draw-textured yarn of Example 9 were determined after the garter was dyed with blue and brown dispersive dyes following the procedures of Examples 7 and 8. The color strengths of the garters dyed with the blue and brown dispersive dyes are 163.03 and 167.24, respectively, compared to the standard value 100 of Comparative Example 3. The color fastness to washing of the garter made in Example 9 is comparable to that of the garter made in Comparative Example 3.

### The Biodegradation Test:

The biodegradation of the draw-textured yarn of Example 7 was tested according to CNS 14432 (ISO 14855, ASTM D5338). The biodegradation rate obtained from the biodegradating test is based on the percentage of carbon dioxide converted from organic carbon contained in the tested draw-textured yarn. The result is shown in Table 8. Table 8 shows that the biodegradation rate of the modified polylactic acid fiber of the present invention can reach 90% in 180 days, which meets the statutory requirement.

TABLE 8

| | Elapsed time (days) | | | | | |
|---|---|---|---|---|---|---|
| | 0 | 15 | 30 | 45 | 50 | 53 |
| Biodegradation (%)* | 0 | 33.23 | 60.13 | 83.89 | 93.27 | 100 |

*measurement based on the carbon dioxide percentage converted from organic carbon contained in the draw-textured yarn.

In view of the aforesaid, the deep-dyeable modified polylactic acid fiber of the present invention has a superior deep-dyeable property while maintaining the acceptable color fastness to washing and biodegradable properties.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A deep-dyeable modified polylactic acid fiber, comprising:
a modified polylactic acid composition which includes polylactic acid and a modifying polymer,
wherein said modifying polymer is a polyester selected from the group consisting of an aliphatic polyester other than polylactic acid, an aromatic polyester, and an aliphatic-aromatic copolyester, and
wherein said modified polylactic acid composition, when dyed, provides a decreased L-value compared to a non-modified polylactic acid composition that is dyed under the same dyeing conditions as said modified polylactic acid composition and that contains said polylactic acid but is free of said modifying polymer.

2. The deep-dyeable modified polylactic acid fiber as claimed in claim 1, wherein the amount of said modifying polymer is 1-15% by weight based on the total weight of the modified polylactic acid composition.

3. The deep-dyeable modified polylactic acid fiber as claimed in claim 1, wherein said aliphatic polyester is represented by formula (I): 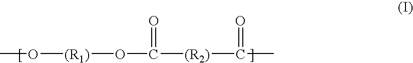
wherein R₁ and R₂ are the same or different, and independently of one another are linear or branched C₂-C₄₀ alkyl.

4. The deep-dyeable modified polylactic acid fiber as claimed in claim 1, wherein said aliphatic-aromatic copolyester is represented by formula (II): 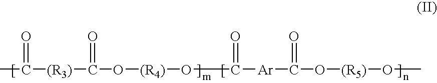
wherein
1≦m≦40;
1≦n≦40;
R₃, R₄, and R₅ are the same or different, and independently of one another are linear or branched C₂-C₄₀ alkyl; and
Ar is C₆-C₂₀ aryl.

5. The deep-dyeable modified polylactic acid fiber as claimed in claim 1, wherein said aromatic polyester is represented by formula (III): 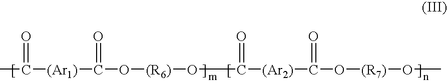
wherein
1≦m≦40;
1≦n≦40;
R₆ is linear or branched C₂-C₄₀ alkyl, or C₆-C₂₀ aryl;
R₇ is linear or branched C₂-C₄₀ alkyl; and
Ar₁ and Ar₂ are the same or different, and independently of one another are C₆-C₂₀ aryl.

6. The deep-dyeable modified polylactic acid fiber as claimed in claim 1, wherein the amount of said modifying polymer is 1-10% by weight based on the total weight of said modified polylactic acid composition.

7. The deep-dyeable modified polylactic acid fiber as claimed in claim 1, wherein the amount of said modifying polymer is 1-5% by weight based on the total weight of said modified polylactic acid composition.

8. The deep-dyeable modified polylactic acid fiber as claimed in claim 3, wherein said aliphatic polyester has a melting point in the range of 30-140° C.

9. The deep-dyeable modified polylactic acid fiber as claimed in claim 4, wherein said aliphatic-aromatic copolyester has a melting point in the range of 50-200° C.

10. The deep-dyeable modified polylactic acid fiber as claimed in claim 5, wherein said aromatic polyester has a melting point in the range of 110-200° C.

11. The deep-dyeable modified polylactic acid fiber as claimed in claim 1, wherein said modifying polymer further includes 4-10% by weight of TiO₂ based on the total weight of said modifying polymer.

12. The deep-dyeable modified polylactic acid fiber as claimed in claim 1, wherein said polyester is selected from the group consisting of polybutylene succinate, polybutylene succinate/adipate, polybutylene adipate, polyethylene succinate/adipate, polybutylene succinate/carbonate, polycaprolactone, polyethylene adipate, polybutylene adipate/terephthalate, polybutylene succinate/terephthalate, polytetramethylene adipate/terephthalate, polyethylene terephthalate/1,3-dihydroxy-2-methylpropane alkoxylate, and polyethylene terephthalate/adipate.

13. A modified polylactic acid composition, comprising:
a polylactic acid, and 1-15% by weight of a modifying polymer based on a total weight of said modified polylactic acid composition,
wherein said modifying polymer is a polyester selected from the group consisting of an aliphatic polyester other than polylactic acid, an aromatic polyester, and an aliphatic-aromatic copolyester, and
wherein said modified polylactic acid composition, when dyed, provides a decreased L-value compared to a non-modified polylactic acid composition that is dyed under the same dyeing conditions as said modified polylactic acid composition and that contains said polylactic acid but is free of said modifying polymer.

14. The modified polylactic acid composition as claimed in claim 13, wherein said polyester is selected from the group consisting of polybutylene succinate, polybutylene succinate/adipate, polybutylene adipate, polyethylene succinate/adipate, polybutylene succinate/carbonate, polycaprolactone, polyethylene adipate, polybutylene adipate/terephthalate, polybutylene succinate/terephthalate, polytetramethylene adipate/terephthalate, polyethylene terephthalate/1,3-dihydroxy-2-methylpropane alkoxylate, and polyethylene terephthalate/adipate.

15. A method for producing a deep-dyeable polylactic acid fabric from the modified polylactic acid composition of claim 13, comprising the steps of:
a) melt spinning the modified polylactic acid composition to form a deep-dyeable polylactic acid fiber; and
b) forming the deep-dyeable polylactic acid fiber into a yarn.

16. The method as claimed in claim 15, wherein the yarn is a partially oriented yarn.

17. The method as claimed in claim 15, wherein the yarn is a draw-textured yarn.

18. The method as clamed in claim 16, wherein the fiber fineness of the partially oriented yarn ranges from 1 to 10 denier/filament, the fiber number thereof is 36, 48, 72, 108, or 144, and the cross section of the fiber of the partially oriented yarn has a circular, oval, trilobal, triangular, dog-boned, flat, or hollow shape.

19. The method as claimed in claim 17, wherein the draw-textured yarn has a fiber fineness ranging from 1 to 10 denier/filament, and the fiber number thereof is 36, 48, 72, 108 or 144.
